(19) United States
(12) Patent Application Publication
(10) Pub. No.: US 2005/0025796 A1
(43) Pub. Date: Feb. 3, 2005

(54) Repellent agent for pigeons

(75) Inventor: Tomowaka Nakamoto, Hiroshima-shi (JP)

Correspondence Address: KODA & ANDROLIA, 2029 CENTURY PARK EAST, SUITE 1430, LOS ANGELES, CA, 90067-3024, US

(73) Assignee: YUGEN GAISHA HIROSHIMAKEN KANKYO SERVICE

(21) Appl. No.: 10/887,174

(22) Filed: Jul. 8, 2004

(30) Foreign Application Priority Data
Jul. 30, 2003 (JP) 2003-282479

(51) Int. Cl. A01N 25/34; A01N 25/00; A01N 65/00

(52) U.S. Cl. 424/405; 424/760

(57) ABSTRACT

A repelling agent for pigeons which is coated in use, including capsaicin and menthol that are added to a tacky base agent formed by mixing a mineral oil or grease and a carboxylic acid polymer thickener, and this mixture is kneaded into a jell-form composition. In this repelling agent (composition) construction, the amount of grease (or mineral oil) is 70 parts by weight per less, the amount of carbomer gel made of a carboxylic acid polymer thickener, hydrating agent and water is 30 parts by weight or less, and the amounts of capsaicin and menthol are one part by weight or less.

### BACKGROUND OF THE INVENTION

1. Field of the Invention

The present invention relates to a jell-form repellent agent that prevents invasion by pigeons.

2. Prior Art

Various types of repellent agents for noxious animals, especially birds, have been proposed. Such agents include one that aims at a repellent effect based on chemicals and tacky agents (so-called birdlime) to be coated as shown in Japanese Patent Application Laid-Open (Kokai) No. 11-286401.

However, tacky agents of this type generally have no weather resistance and, therefore, they are deficient in terms of the duration of the repellent effect. Furthermore, such agents are difficult to wipe away once applied as a coating.

Repellent agents that attack the sensory organs of birds would include agents that attack the sense of taste or the sense of smell, besides agents that attack the tactile sense of birds as shown in the above-described prior art.

### SUMMARY OF THE INVENTION

Under these circumstances, the inventor of the present application has created a repellent agent (composition); and this repellent agent has a composite repellent effect including tackiness with respect to the tactile sense (by tackifying jell), taste-irritating properties with respect to the sense of taste or sense of pain (by capsaicin), and pervasiveness of a fragrance (or cold stimulus properties) with respect to the sense of smell (by mint), and in addition, the repellent agent is not harmful to the human body.

In other words, the present invention provides a repellent agent for pigeons which solves the problems with the prior art agents, which has a composite repellent effect that attacks the sense of touch, the sense of taste and the sense of smell of birds, and which is not harmful to the human body.

More specifically, the present invention provides a repellent agent for birds or pigeons which is used by being applied as a coating, and this agent is characterized by the fact that capsaicin and menthol are added to a tacky base agent formed by mixing a mineral oil or grease with a carboxylic acid polymer thickener, and the resulting mixture is kneaded to produce a jell-form composition.

The repellent agent of the present invention, which is not harmful to the human body, can be used by being applied to or coated on places where pigeons tend to alight, such as the roofs of residential buildings or the railings of verandahs, etc. The repellent agent has a composite repellent effect against pigeons, attacking the sense of touch, the sense of taste and the sense of smell. Furthermore, the repellent agent of the present invention can be produced inexpensively.

### DETAILED DESCRIPTION OF THE INVENTION

The repellent agent of the present invention is, per 100 parts by weight, comprised of 70 parts by weight or less of a grease or mineral oil, 30 parts by weight or less of a semi-solid material that includes a carboxylic acid polymer thickener, a hydrating agent and water (hereafter called a “carbomer gel”), and one part by weight or less of capsaicin and menthol; and these substances are mixed together.

More specifically, the repellent agent composition contains 70 parts by weight of grease, 29 parts by weight of a carbomer gel, 0.7 parts by weight of capsaicin (concentrated liquid), and 0.3 parts by weight of menthol (fine powder particles), which are mixed.

The above-described carboxylic acid polymer thickeners include acrylic acid homopolymers that are used as thickeners in cosmetics, such as carboxyvinyl polymers (carbomers). Products in the Carbopol (trademark) 900 series manufactured by B. F. Goodrich Co. can be obtained as commercially marketed products in a dry powdered state.

The carbomer gel described above is, using the creme-form tackiness of cosmetics as a standard, obtained by adding several tens of grams of Carbopol and several grams of a hydrating agent (preferably triethanolamine) to 10 liters of water, and agitating this mixture.

The above-described grease and carbomer gel are combined, capsaicin (concentrated liquid) and menthol (fine powder particles) are added thereto, and this mixture is kneaded. As is well known, capsaicin and menthol are food additives, and commercially marketed products thereof can easily be obtained.

Examples of the repellent agent of the present invention will be described below based on experimental facts (field tests); however, the scope of the present invention should not be affected by how large or small areas the examples are applied in the actual use.

In one example, hollows were present on each floor in the outside walls of a six-story building. Pigeons would frequently alight in these hollows and leave droppings, so that there were complaints from the users of the building. When these hollows (flat surface portions) were applied and coated with the repellent agent of the present invention in stripe form by tube extrusion, pigeons ceased to appear from the following day onward, and there was no trace of pigeons in six months. Thus, the desired effect was recognized.

It was confirmed that the repellent effect of the repellent agent of the present invention lasts for a long time after application. It is inferred that this is attributable to the fact that an oily film is formed on the coating surface, and this film acts as a protective film, providing weather resistance.

In another example, pigeons would frequently alight on the verandahs of the respective floors of a four-story building, and these pigeons would build nests under outdoor air conditioning units installed on the verandahs as well as leaving droppings. This resulted in the soiling of laundry hung out to dry, so that there were complaints from the inhabitants of the building. When the railings of the verandahs, the top surfaces of the outdoor air conditioning units and the areas around the nests were applied and coated (area coating) with the repellent agent of the present invention, the appearance of pigeons ceased after one week, and no appearance of pigeons was seen in one month. The desired effect was thus recognized.

The repellent agent of the present invention was also used in several tens of other locations. In all cases, the results were good, and the desired effect was recognized.

There are no particular conditions on the manner of coating. In cases where the repellent agent is applied to a broad area, mechanical coating using a caulking machine is possible.

In cases where the appearance of pigeons has ceased, and the repellent agent of the present invention is to be removed, the agent can be removed without leaving any remaining agent by scraping the agent away with a scraper and then wiping the area with a rag or the like. Thus, the cleaning is easy.

As seen from the above, the repellent agent for pigeons of the present invention is harmless to the human body and can easily be applied and removed (cleaned away). Accordingly, the agent of the present invention is practical, and it has industrial applicability in terms of making a great contribution to the prevention (discouragement) of noxious behavior by pigeons, which have invaded living spaces in recent years.

1. A repellent agent for pigeons which is coated in use, wherein the repellent agent is comprised of:
a tacky base agent formed by mixing a carboxylic acid polymer thickener with one selected from the group consisting of mineral oil and grease, and
capsaicin and menthol which are added to said tacky base agent; and
a resulting mixture is kneaded into a jell-form composition.
